(19) United States
(12) Patent Application Publication
(10) Pub. No.: US 2025/0119874 A1
(43) Pub. Date: Apr. 10, 2025

(54) UPLINK TRANSMISSION INDICATION AND DETERMINATION METHODS, COMMUNICATION APPARATUS, AND STORAGE MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/721,771

(22) PCT Filed: Dec. 20, 2021
(86) PCT No.: PCT/CN2021/139752

§ 371 Date: Jun. 19, 2024

(51) Int. Cl. H04W 72/02; H04W 72/0446; H04W 72/0453

(52) U.S. Cl. CPC H04W 72/02; H04W 72/0446; H04W 72/0453

(57) ABSTRACT

A method, a communication apparatus, and a storage medium for uplink transmission indication and determination. The uplink transmission indication is determined by: sending uplink indication information to a terminal, the uplink indication information being used to indicate to the terminal an uplink resource for uplink transmission among downlink resources for downlink transmission.

### CROSS REFERENCE TO RELATED APPLICATIONS

The present application is a U.S. National Stage of International Application No. PCT/CN2021/139752 filed on Dec. 20, 2021, the content of which is incorporated herein by reference in its entirety.

### TECHNICAL FIELD

The present disclosure relates to the technical field of communication, in particular to an uplink transmission indication method, an uplink transmission determination method, communication apparatuses, and computer-readable storage media.

### BACKGROUND

In order to increase throughput, reduce transmission delay, and enhance uplink coverage, it can be considered that a terminal communicates in a full-duplexing mode, for example, performs uplink transmission at the same time on a downlink frequency domain resource for downlink transmission.

However, based on a current protocol, the terminal cannot perform uplink transmission at the same time on the downlink frequency domain resource for downlink transmission. Therefore, there is no clear way to indicate a resource for the terminal to perform communication in the full-duplexing mode.

### SUMMARY

According to a first aspect of an embodiment of the present disclosure, provided is an uplink transmission indication method performed by a network-side device, where the method includes: sending uplink indication information to a terminal, where the uplink indication information is for indicating an uplink resource for uplink transmission in a downlink resource for downlink transmission of the terminal.

According to a second aspect of an embodiment of the present disclosure, provided is an uplink transmission determination method performed by a terminal, where the method includes: receiving uplink indication information sent by a network-side device; and determining an uplink resource for uplink transmission in a downlink resource for downlink transmission according to the uplink indication information.

According to a third aspect of an embodiment of the present disclosure, provided is a communication apparatus, including: a processor; and a memory for storing a computer program; where the processor executes the computer program to implement operations including: sending uplink indication information to a terminal, where the uplink indication information is for indicating an uplink resource for uplink transmission in a downlink resource for downlink transmission of the terminal.

According to a fourth aspect of an embodiment of the present disclosure, provided is a non-transitory computer-readable storage medium for storing a computer program, where the computer program is executed by a processor to implement the uplink transmission indication method according to any one of the above-mentioned embodiments.

### BRIEF DESCRIPTION OF DRAWINGS

In order to describe the technical solutions in the embodiments of the present disclosure more clearly, the accompanying drawings required for describing the embodiments will be briefly introduced below. Apparently, the accompanying drawings in the following description show only some embodiments of the present disclosure, and those of ordinary skill in the art may still derive other accompanying drawings from these accompanying drawings without creative efforts.

FIG. 1 is a schematic flow diagram illustrating an uplink transmission indication method according to an embodiment of the present disclosure;

FIG. 2 is a schematic diagram illustrating a downlink resource according to an embodiment of the present disclosure;

FIG. 3 is a schematic diagram illustrating an uplink frequency domain resource according to an embodiment of the present disclosure;

FIG. 4 is a schematic diagram illustrating an uplink frequency domain resource and an uplink time domain resource according to an embodiment of the present disclosure;

FIG. 5 is a schematic diagram illustrating another uplink frequency domain resource and another uplink time domain resource according to an embodiment of the present disclosure;

FIG. 6 is a schematic flow diagram illustrating another uplink transmission indication method according to an embodiment of the present disclosure;

FIG. 7 is a schematic flow diagram illustrating an uplink transmission determination method according to an embodiment of the present disclosure;

FIG. 8 is a schematic flow diagram illustrating another uplink transmission determination method according to an embodiment of the present disclosure;

FIG. 9 is a schematic block diagram illustrating an uplink transmission indication apparatus according to an embodiment of the present disclosure;

FIG. 10 is a schematic block diagram illustrating another uplink transmission indication apparatus according to an embodiment of the present disclosure;

FIG. 11 is a schematic block diagram illustrating further uplink transmission indication apparatus according to an embodiment of the present disclosure;

FIG. 12 is a schematic block diagram illustrating an uplink transmission determination apparatus according to an embodiment of the present disclosure;

FIG. 13 is a schematic block diagram illustrating an apparatus for uplink transmission indication according to an embodiment of the present disclosure; and

FIG. 14 is a schematic block diagram illustrating an apparatus for uplink transmission determination according to an embodiment of the present disclosure.

### DETAILED DESCRIPTION

The technical solutions in the embodiments of the present disclosure will be described clearly and completely below in conjunction with the accompanying drawings in the embodiments of the present disclosure. Apparently, the described embodiments are only a part of the embodiments of the present disclosure, but not all of the embodiments. Based on the embodiments of the present disclosure, all other embodiments obtained by those of ordinary skill in the art without creative efforts shall fall within the protection scope of the present disclosure.

Terms used in the embodiments of the present disclosure are only for the purpose of describing specific embodiments, rather than limiting the embodiments of the present disclosure. “A” and “this” in a singular form used in the embodiments and the appended claims of the present disclosure are also intended to include a plural form unless other meanings are clearly expressed in a context. It should be further understood that the term “and/or” used herein refers to and includes any or all possible combinations of one or more associated listed items.

It should be understood that terms such as first, second, and third may be adopted in the embodiments of the present disclosure to describe various information, but the information should not be limited to these terms. These terms are only intended to distinguish the same kind of information from each other. For example, without departing from the scope of the embodiments of the present disclosure, first information may also be referred to as second information, and similarly, the second information may also be referred to as the first information. Depending on a context, for example, the word “if” used herein can be interpreted as “while,” “when,” or “in response to determining”.

For the purposes of simplifying and facilitating understanding, terms used herein to characterize a size relationship are “greater than,” “smaller than,” “higher than,” or “lower than.” However, for the skilled in the art, it can be understood that the term “greater than” also covers the meaning of “greater than or equal to,” “smaller than” also covers the meaning of “smaller than or equal to”; the term “higher than” covers the meaning of “higher than or equal to,” and “lower than” also covers the meaning of “lower than or equal to.”

In view of this, embodiments of the present disclosure provide an uplink transmission indication method, an uplink transmission determination method, an uplink transmission indication apparatus, an uplink transmission determination apparatus, communication apparatuses, and computer-readable storage media to solve technical problems in the related art.

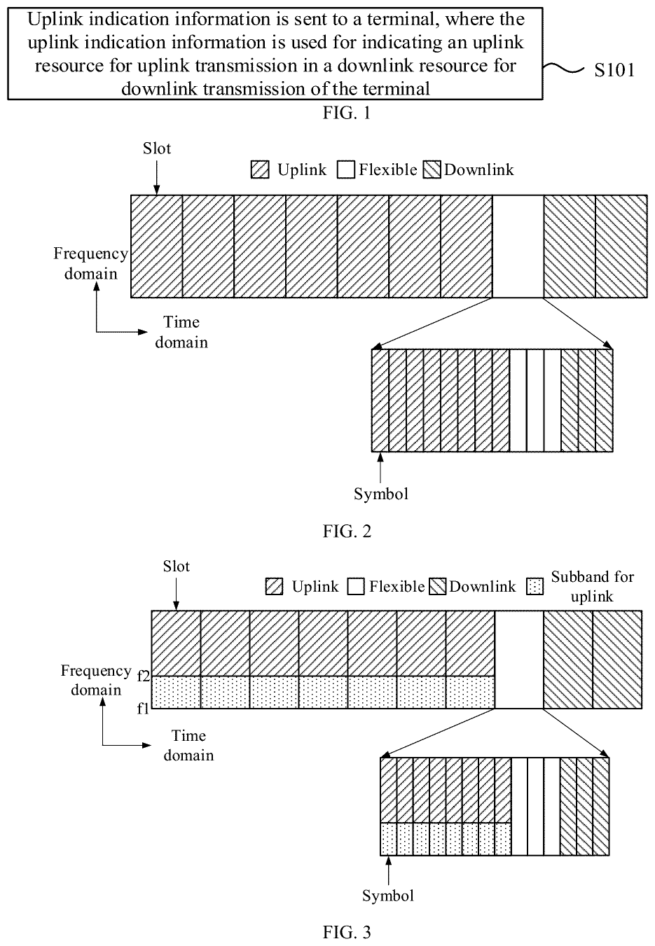

FIG. 1 is a schematic flow diagram illustrating an uplink transmission indication method according to an embodiment of the present disclosure. The uplink transmission indication method shown in the present embodiment can be performed by a network-side device which can communicate with a terminal. The terminal includes, but is not limited to a communication apparatus such as a mobile phone, a tablet personal computer, a wearable device, a sensor, and an Internet-of-things device; and the network-side device includes, but is not limited to a network-side device, such as a base station and a core network, in a communication system such as 4G, 5G and 6G.

As shown in FIG. 1, the uplink transmission indication method can include the following steps:
in step S101, uplink indication information is sent to a terminal, where the uplink indication information is used to indicate an uplink resource for uplink transmission in a downlink resource for downlink transmission of the terminal.

In an embodiment, the network-side device can configure the downlink resource for downlink transmission of the terminal firstly, and then send the uplink indication information to the terminal when the terminal is required later to perform communication in a full-duplexing mode.

The network-side device can also configure the downlink resource for downlink transmission of the terminal and indicate the uplink resource at the same time. For example, the network-side device can send configuration signaling to the terminal, where downlink configuration information and uplink indication information are carried in the configuration signaling. On the one hand, the downlink configuration information can indicate the downlink resource for downlink transmission of the terminal, on the other hand, the uplink indication information can indicate the uplink resource for uplink transmission in the downlink resource.

It should be noted that the downlink resource for downlink transmission and the uplink resource for uplink transmission can be resources which are the same in frequency domain and time domain. For example, they are located in the same slot in time domain and are located in the same frequency band in frequency domain, where the slot includes, but is not limited to a Time Division Duplexing (TDD) downlink slot and a Frequency Division Duplexing (FDD) downlink slot.

In an embodiment, the uplink indication information includes at least one of following information:
frequency domain indication information for indicating an uplink frequency domain resource for uplink transmission in a downlink frequency domain resource for downlink transmission of the terminal; or
time domain indication information for indicating an uplink time domain resource for uplink transmission in a downlink time domain resource for downlink transmission of the terminal.

That is, on the one hand, the uplink indication information can indicate the uplink frequency domain resource through the frequency domain indication information, and on the other hand, the uplink indication information can indicate the uplink time domain resource through the time domain indication information, so that the terminal determines the uplink time domain resource and the uplink frequency domain resource which are used for uplink transmission.

The uplink resource is in the downlink resource, and therefore, in the uplink resource indicated by the indication information, the terminal not only can perform uplink transmission, but also can perform downlink transmission.

Moreover, the uplink resource is in the downlink resource, and therefore, the uplink resource cannot exceed the downlink resource. For example, the downlink resource includes the downlink frequency domain resource and the downlink time domain resource, then, the uplink frequency domain resource indicated by the frequency domain indication information cannot exceed the downlink frequency domain resource. For example, the downlink frequency domain resource is a frequency band. In an embodiment, the uplink frequency domain resource includes at least one subband in the downlink frequency domain resource; and correspondingly, the uplink time domain resource indicated by the time domain indication information cannot exceed the downlink time domain resource, either. For example, the downlink time domain resource includes n slots, and then, the uplink time domain resource occupies the n slots, where n is an integer greater than or equal to 1.

According to the embodiments of the present disclosure, the network-side device can indicate the uplink resource for uplink transmission in the downlink resource for downlink transmission of the terminal by sending the uplink indication information to the terminal. Therefore, the terminal can perform uplink transmission on the indicated uplink resource, thereby achieving full-duplexing communication which is beneficial to the increase of a throughput, the reduction of transmission delay and the enhancement of uplink coverage.

In an embodiment, the terminal can uplink transmit corresponding contents on the uplink resource as required, for example, uplink transmitting data, a reference signal or a Physical Uplink Control Channel (PUCCH).

In an embodiment, the uplink indication information is carried in at least one of following items:
system information, such as a system information block, such as SIB1;
Radio Resource Control (RRC) signaling;
specific Downlink Control Information (DCI);
group common DCI; or
a Media Access Control Control Element (MAC CE).

In an embodiment, the network-side device can send the uplink indication information to the terminal by carrying the uplink indication information in the system information and broadcasting the system information, for example, carrying the uplink indication information in the broadcast SIB1;
in an embodiment, the network-side device can send the uplink indication information to the terminal by carrying the uplink indication information in the RRC signaling and sending the RRC signaling to the terminal;
in an embodiment, the network-side device can send the uplink indication information to a specified terminal by carrying the uplink indication information in a specific DCI and sending the specific DCI to the specified terminal;
in an embodiment, the network-side device can send the uplink indication information to terminals in a group (such as terminals in a cell) by carrying the uplink indication information in the group common DCI and sending the group common DCI to the terminals, where a format of the group common DCI includes, but is not limited to a DCI format 2_0; and
in an embodiment, the network-side device can send the uplink indication information to the terminal by carrying the uplink indication information in the MAC CE and sending the MAC CE to the terminal.

In an embodiment, in the case that the uplink indication information is carried in the system information or the RRC signaling:
the frequency domain indication information is used for indicating a frequency domain starting position and a frequency domain occupation length of the uplink frequency domain resource, or the frequency domain indication information is used for indicating a frequency domain starting position and a frequency domain ending position of the uplink frequency domain resource.

When the uplink indication information is carried in the system information or the RRC signaling, generally, the system information or the RRC signaling are not dynamically sent by the network-side device, and therefore, it is not easy to achieve dynamic scheduling. Therefore, the uplink frequency domain resource can be scheduled in a semi-static mode.

For example, the frequency domain starting position and the frequency domain occupation length of the uplink frequency domain resource are indicated by the frequency domain indication information, so that the terminal determines the uplink frequency domain resource according to the frequency domain starting position and the frequency domain occupation length, for example, the frequency domain starting position is frequency x, and the frequency domain occupation length is y, then, the uplink frequency domain resource can be a frequency band with the length y starting from frequency x; and

for example, the frequency domain starting position and the frequency domain ending position of the uplink frequency domain resource are indicated by the frequency domain indication information, so that the terminal determines the uplink frequency domain resource according to the frequency domain starting position and the frequency domain ending position, for example, the frequency domain starting position is frequency x1, and the frequency domain ending position is frequency x2, then, the uplink frequency domain resource can be a frequency band between frequency x1 and frequency x2.

Therefore, after determining the uplink frequency domain resource, the terminal can perform uplink transmission by using the uplink frequency domain resource within indicated uplink time domain resource.

In an embodiment, in the case that the uplink indication information is carried in the system information, the RRC signaling, or the group common DCI:
the time domain indication information includes time domain pattern information.

When the uplink indication information is carried in the system information or the RRC signaling, generally, the system information and the RRC signaling are not dynamically sent by the network-side device, and therefore, it is not easy to achieve dynamic scheduling. Therefore, the uplink time domain resource can be scheduled in a semi-static mode. For example, in this case, the time domain indication information can include the time domain pattern information, such as a time domain pattern information bitmap by which the uplink time domain resource is indicated.

For example, the uplink frequency domain resource is the subband, and then the terminal can determine, according to the time domain pattern information, a time domain resource where the subband is located, for example, the slot where the subband is located. The time domain resource corresponding to the time domain pattern information can be continuous, for example, there are a plurality of continuous slots; and the time domain resource can also be discontinuous, for example, there are a plurality of spaced slots, for example, the plurality of slots can be periodic slots.

Of course, in addition to that the uplink indication information is carried in the system information or the RRC signaling, the uplink time domain resource can be indicated by the time domain pattern information. When the uplink indication information is carried in other modes, the uplink time domain resource can also be indicated as required according to the time domain pattern information. For example, when the uplink indication information is carried in the DCI, specifically, when it is carried in the group common DCI, the time domain indication information can also include the time domain pattern information (such as the bitmap), that is, in this case, the uplink time domain resource can also be indicated by the time domain pattern information.

In an embodiment, the specific DCI includes at least one of following information:
specific DCI for scheduling downlink transmission; and
specific uplink control information for scheduling uplink transmission.

The specific DCI carrying the uplink indication information is sent for the specified terminal, and therefore, it can be specifically referred to as user equipment (UE) specific DCI, where the UE refers to the specified terminal.

The specific DCI can be the specific DCI for scheduling downlink transmission of the terminal, in this case, the terminal can determine a downlink transmission resource according to the specific DCI, and can also determine an uplink transmission resource according to the uplink indication information in the specific DCI; and
the specific DCI can also be the specific uplink control information for scheduling uplink transmission of the terminal, in this case, a part of contents in the specific DCI can be used as the uplink indication information. For example, the terminal can determine a part of contents, used as the uplink indication information, in the specific DCI according to an agreement, and can also determine a part of contents, used as the uplink indication information, in the specific DCI according to an indication from the network-side device.

In an embodiment, the uplink indication information includes a newly added field in the specific DCI. That is, compared with the specific DCI in the related art, a field (such as a new information domain) can be newly added therein, and the newly added field is used as the uplink indication information to indicate the uplink resource.

In an embodiment, in the case that the specific DCI is the specific uplink control information for scheduling uplink transmission, the uplink indication information includes a part of bits in a frequency domain resource assignment domain in the specific DCI.

In the case that the specific DCI is the specific uplink control information, the uplink frequency domain resource can be assigned by the Frequency Domain Resource Assignment (FDRA) domain in the specific DCI.

It should be noted that assigning the uplink frequency domain resource and indicating the uplink frequency domain resource are different meanings. Indicating the uplink frequency domain resource is to indicate the uplink frequency domain resource for uplink transmission in the downlink frequency domain resource for downlink transmission, for example, to indicate a subband for uplink transmission in a downlink frequency band for downlink transmission; and assigning the uplink frequency domain resource is to assign an Resource Block (RB) for uplink transmission in a determined uplink frequency domain resource (such as the above-mentioned subband).

At present, the FDRA domain aims at assigning the uplink frequency domain resource, and a length of the FDRA domain is related to a size of an activated Bandwidth Part (BWP). For example, the length of the FDRA domain is 10 bits, then, in a general case, it is not all the bits in the FDRA domain that are used for assigning the uplink frequency domain resource. Therefore, in the present embodiment, a part of the bits in the FDRA domain can be used as the uplink indication information, for example, N (Nis an integer greater than 0) Most Significant Bit (MSB) or N Least Significant Bit (LSB) in the FDRA domain can be used as the uplink indication information.

With N MSB in the FDRA domain as the uplink indication information as an example, if the length of the FDRA domain is 10 bits, and N is 2 bits, first two bits in the FDRA domain can be used as the uplink indication information, and the last eight bits are still used for uplink resource assignment. Therefore, the FDRA domain can be fully utilized to indicate the uplink resource without changing an information domain in existing DCI.

In an embodiment, the network-side device can configure, through the RRC signaling, N MSB or N LSB as the uplink indication information to indicate the uplink resource;
or, the network-side device can pre-configure a plurality of candidate resources (which will be specifically described in subsequent embodiments) for the terminal, for example, C candidate resources are pre-configured, and the terminal can determine a value of N according to the number C of the candidate resources, for example, N=ceil(log₂(C));
or, the terminal can pre-store a corresponding relationship between an uplink Bandwidth Part (BWP) for uplink transmission and the value of N, and then implicitly determine the corresponding value of N in the corresponding relationship according to the currently activated uplink BWP.

In an embodiment, the method further includes:
a length of the FDRA domain is determined according to an activated uplink bandwidth part.

In an embodiment, there may be an association relationship between the length (the number of the corresponding bits) of the FDRA domain and the BWP. In the present embodiment, the uplink resource is located in the downlink resource, but the FDRA domain in the specific DCI is used for frequency domain resource assignment for the uplink resource, and therefore, the length of the FDRA domain needs to be determined according to the activated uplink BWP (the bandwidth is smaller than or equal to a downlink BWP), for example, the length of the FDRA domain corresponding to the activated uplink BWP can be determined in the association relationship between the length of the FDRA domain and the BWP. Then, after the length of the FDRA domain is determined, N bits in the FDRA domain can be determined as the uplink indication information, and other bits are used for frequency domain resource assignment.

In an embodiment, in the case that the uplink indication information is carried in the specific DCI or the group common DCI:
the uplink indication information is used for indicating the uplink resource in a plurality of predetermined candidate resources.

In an embodiment, the plurality of predetermined candidate resources can be pre-configured for the terminal by the network-side device through high-layer signaling (such as the RRC signaling), or can be predetermined by the network-side device and the terminal according to an agreement, and then, the network-side device can select one resource from the plurality of candidate resources as required and indicate it to the terminal through the uplink indication information (for example, carried in the specific DCI), for example, indicate an identifier corresponding to the selected resource to the terminal.

In an embodiment, for example, the network-side device can pre-configure a corresponding relationship between each of the plurality of candidate resources and the identifier for the terminal, and a storage mode of the corresponding relationship includes, but is not limited to a table, such as Table 1 shown as follows:

TABLE 1

| Identifier | Candidate resource |
|---|---|
| (Subband indicator) | (Subband configuration) |
| 00 | First set of configurations in configuration |
| | list |
| 01 | Second set of configurations in |
| | configuration list |
| 10 | Third set of configurations in configuration |
| | list |
| 11 | Fourth set of configurations in |
| | configuration list |

As shown in Table 1, for example, the candidate resources can be specifically a set of configurations including the uplink time domain resource and the uplink frequency domain resource, and the configurations can, for example, include a starting position of a subband, a frequency domain occupation length of the subband, and time domain pattern information. For example, there are C configurations, i.e., C candidate resources, then, the network-side device can indicate the selected resource by N bits, where N-ceil(log₂(C)). For example, there are four sets of configurations in Table 1, i.e., four candidate resources, then, the network-side device can indicate the selected resource by two bits, for example, the uplink indication information is 01 which represents that the terminal is indicated to perform uplink transmission by using the second set of configurations.

It can be understood that each element in Table 1 exists independently, these elements are exemplarily listed in the same table, but it does not mean that all the elements in the table necessarily coexist according to the table. A value of each element is independent of a value of any other element in Table 1. Therefore, it can be understood by the skilled in the art that the value of each element in Table 1 is an independent embodiment.

The uplink frequency domain resource and the uplink time domain resource which are indicated by the uplink indication information are described as examples below in conjunction with embodiments.

FIG. 2 is a schematic diagram illustrating a downlink resource according to an embodiment of the present disclosure.

As shown in FIG. 2, the downlink resource includes a frequency band in frequency domain and includes a TDD downlink slot in time domain. For example, a downlink slot structure includes seven downlink slots, one flexible slot, and two uplink slots, i.e., a DDDDDDDSUU structure, with each slot including fourteen time domain symbols. In the flexible slot, the first eight symbols are used for downlink transmission, the next three symbols are flexible symbols, and the last three symbols are used for uplink transmission. In this case, the downlink resource includes the seven downlink slots and the first eight symbols in the flexible slot in time domain.

FIG. 3 is a schematic diagram illustrating an uplink frequency domain resource according to an embodiment of the present disclosure.

According to the embodiment of the present disclosure, for example, the uplink indication information includes frequency domain indication information which may indicate that the uplink frequency domain resource includes at least one subband in the downlink frequency domain resource. As shown in FIG. 3, the subband may range from frequency f1 to frequency f2 in frequency domain, then the terminal can perform uplink communication by using the subband indicated by the indication information.

In the case that there is no uplink time domain information indicated, uplink communication can be performed within all the time domain range of the downlink resource. In the case that there is the uplink time domain information indicated, uplink communication can be performed within a time domain range indicated by the uplink time domain information.

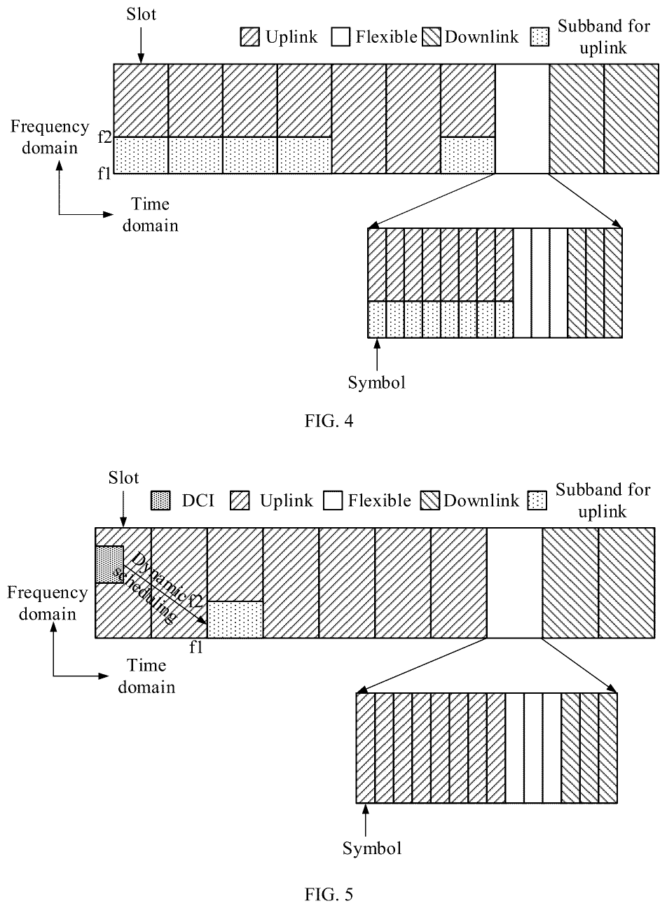

FIG. 4 is a schematic diagram illustrating an uplink frequency domain resource and an uplink time domain resource according to an embodiment of the present disclosure.

In an embodiment, the time domain indication information can indicate the uplink time domain resource according to the time domain pattern information, the length of the bitmap is k (k is an integer greater than 0) bits, each bit corresponds to a time domain element which is a slot and can also be a radio frame or a time domain element configured by a base station.

As shown in FIG. 4, the length of the bitmap is ten bits, each bit corresponds to one slot, the time domain pattern information is denoted as 1111001100 by the bitmap, which means that six slots including slot 1 to slot 4 and slot 7 to slot 8 are used for uplink transmission, four slots including slot 5 to slot 6 and slot 9 to slot 10 are not used for uplink transmission. Then, the terminal can perform uplink transmission on uplink symbols in slot 1 to slot 4 and slot 7 to slot 8 by using the subband indicated by the frequency indication information.

It should be noted that the situations indicated in FIG. 3 and FIG. 4 are suitable for a situation that the uplink indication information is carried in the system information or the RRC signaling. The system information or the RRC signaling is not dynamically sent, and therefore, it is not easy to achieve dynamic scheduling. Therefore, the uplink resource can be scheduled in a semi-static mode. After scheduling is preformed once, the terminal will determine the uplink resource in subsequent radio frames according to the uplink indication information in this scheduling, that is, the uplink resource may be the same in each radio frame.

FIG. 5 is a schematic diagram illustrating another uplink frequency domain resource and another uplink time domain resource according to an embodiment of the present disclosure.

When the uplink indication information is carried in the specific DCI, the specific DCI can be dynamically sent, and therefore, dynamic scheduling can be achieved. Therefore, the uplink resource can be scheduled in a dynamic mode. For example, as shown in FIG. 5, the network-side device can send the specific DCI to the terminal at slot 1, and the terminal is dynamically scheduled to perform uplink communication in the subband at slot 3. Since the specific DCI can be dynamically sent, the terminal can determine the uplink resource in the subsequent slots and radio frames according to the uplink indication information in the specific DCI dynamically sent by the network-side device, and does not necessarily determine subsequent uplink resources according to the uplink indication information in one scheduling.

It should be noted that the uplink time domain resources indicated by the uplink indication information is included in the downlink time domain resource, and therefore, the terminal can also preform downlink communication on these uplink time domain resources; and the downlink frequency domain resource used for the terminal to perform downlink communication and the subband indicated by the frequency domain indication information can belong to the same frequency band, and therefore, the terminal can perform uplink communication and downlink communication in this frequency band at the same time to achieve full-duplexing communication.

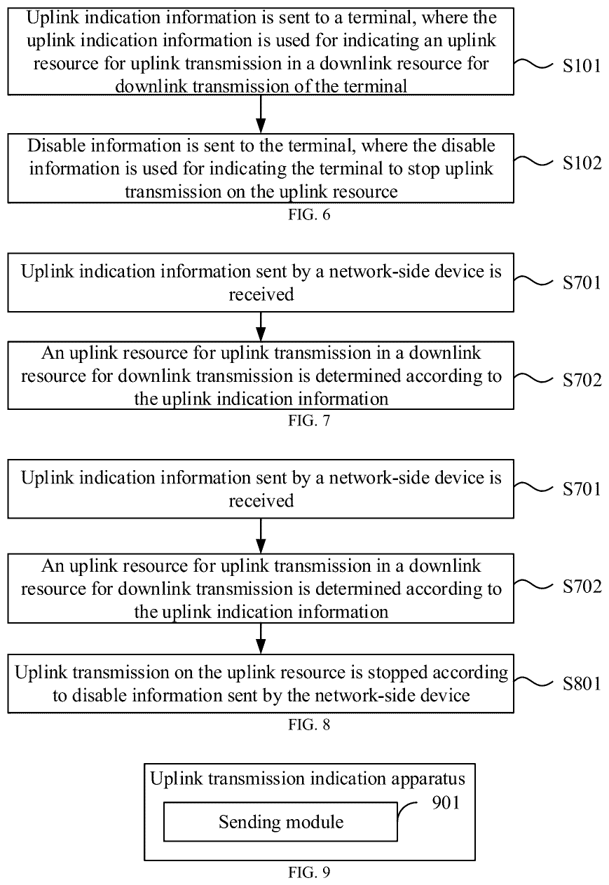

FIG. 6 is a schematic flow diagram illustrating another uplink transmission indication method according to an embodiment of the present disclosure. As shown in FIG. 6, the method further includes:
in step S602, disable information is sent to the terminal, where the disable information is used for instructing the terminal to stop uplink transmission on the uplink resource.

In an embodiment, the network-side device may also send the disable information to the terminal so as to instruct the terminal to stop uplink transmission on the uplink resource indicated by the uplink indication information. The disable information can be carried in the DCI, for example, it can be carried in the group common DCI.

FIG. 7 is a schematic flow diagram illustrating an uplink transmission determination method according to an embodiment of the present disclosure. The uplink transmission determination method shown in the present embodiment can be performed by a terminal which can communicate with a network-side device. The terminal includes, but is not limited to a communication apparatus such as a mobile phone, a tablet personal computer, a wearable device, a sensor, and an Internet-of-things device; and the network-side device includes, but is not limited to a network-side device, such as a base station and a core network, in a communication system such as 4G, 5G and 6G.

As shown in FIG. 7, the uplink transmission determination method includes:
in step S701, uplink indication information sent by a network-side device is received; and
in step S702, an uplink resource for uplink transmission in a downlink resource for downlink transmission is determined according to the uplink indication information.

In an embodiment, the terminal can determine the downlink resource for downlink transmission firstly according to a configuration of the network-side device, and then further determine the uplink resource for uplink transmission in the downlink resource for downlink transmission according to the uplink indication information sent by the network-side device.

The network-side device can also configure the downlink resource for downlink transmission of the terminal and indicate the uplink resource at the same time. For example, the network-side device can send configuration signaling to the terminal, where downlink configuration information and uplink indication information are carried in the configuration signaling. On the one hand, the downlink configuration information can indicate the downlink resource for downlink transmission of the terminal, on the other hand, the uplink indication information can indicate the uplink resource for uplink transmission in the downlink resource.

It should be noted that the downlink resource for downlink transmission and the uplink resource for uplink transmission can be resources which are the same in frequency domain and time domain. For example, they are located in the same slot in time domain and are located in the same frequency band in frequency domain, where the slot includes, but is not limited to a TDD downlink slot and an FDD downlink slot.

The uplink indication information includes at least one of following information:
frequency domain indication information; or
time domain indication information;
where the step that the uplink resource for uplink transmission in the downlink resource for downlink transmission is determined according to the uplink indication information includes at least one of following steps:
the uplink frequency domain resource for uplink transmission in the downlink frequency domain resource for downlink transmission is determined according to the frequency domain indication information; or
the uplink time domain resource for uplink transmission in the downlink time domain resource for downlink transmission is determined according to the time domain indication information.

That is, on the one hand, the terminal can determine the uplink frequency domain resource through the frequency domain indication information in the uplink indication information, and on the other hand, the terminal can determine the uplink time domain resource through the time domain indication information in the uplink indication information.

The uplink resource is in the downlink resource, and therefore, in the uplink resource indicated by the indication information, the terminal not only can perform uplink transmission, but also can perform downlink transmission.

Moreover, the uplink resource is in the downlink resource, and therefore, the uplink resource cannot exceed the downlink resource. For example, the downlink resource includes the downlink frequency domain resource and the downlink time domain resource, then, the uplink frequency domain resource indicated by the frequency domain indication information cannot exceed the downlink frequency domain resource. For example, the downlink frequency domain resource is a frequency band. In an embodiment, the uplink frequency domain resource includes at least one subband in the downlink frequency domain resource; and correspondingly, the uplink time domain resource indicated by the time domain indication information cannot exceed the downlink time domain resource, either. For example, the downlink time domain resource includes n slots, and then, the uplink time domain resource occupies the n slots, where n is an integer greater than or equal to 1.

According to the embodiments of the present disclosure, the terminal can receive the uplink indication information sent by the network-side device, and then determine the uplink resource for uplink transmission in the downlink resource for downlink transmission according to the uplink indication information. Therefore, the terminal can perform uplink transmission on the determined uplink resource, thereby achieving full-duplexing communication which is beneficial to the increase of a throughput, the reduction of transmission delay and the enhancement of uplink coverage.

In an embodiment, the terminal can uplink transmit corresponding contents on the uplink resource as required, for example, uplink transmit data, a reference signal or a PUCCH.

In an embodiment, the uplink indication information is carried in at least one of following items:
system information, such as a system information block, such as SIB1;
RRC signaling;
specific DCI;
group common DCI; or
an MAC CE.

In an embodiment, the network-side device can send the uplink indication information to the terminal by carrying the uplink indication information in the system information and broadcasting the system information, for example, carrying the uplink indication information in the broadcast SIB1;
in an embodiment, the network-side device can send the uplink indication information to the terminal by carrying the uplink indication information in the RRC signaling and sending the RRC signaling to the terminal;
in an embodiment, the network-side device can send the uplink indication information to a specified terminal by carrying the uplink indication information in a specific DCI and sending the specific DCI to the specified terminal;
in an embodiment, the network-side device can send the uplink indication information to terminals in a group (such as terminals in a cell) by carrying the uplink indication information in the group common DCI and sending the group common DCI to the terminals, where a format of the group common DCI includes, but is not limited to a DCI format 2_0; and
in an embodiment, the network-side device can send the uplink indication information to the terminal by carrying the uplink indication information in the MAC CE and sending the MAC CE to the terminal.

In an embodiment, in the case that the uplink indication information is carried in the system information or the RRC signaling, the step that the uplink resource for uplink transmission in the downlink resource for downlink transmission is determined according to the uplink indication information includes:
a frequency domain starting position and a frequency domain occupation length of the uplink frequency domain resource are determined according to the frequency domain indication information, or a frequency domain starting position and a frequency domain ending position of the uplink frequency domain resource are determined according to the frequency domain indication information.

When the uplink indication information is carried in the system information or the RRC signaling, generally, the system information or the RRC signaling is not dynamically sent, and therefore, it is not easy to achieve dynamic scheduling. Therefore, the uplink frequency domain resource can be scheduled in a semi-static mode.

For example, the terminal can determine the uplink frequency domain resource according to the frequency domain starting position and the frequency domain occupation length which are indicated by the frequency domain indication information, for example, the frequency domain starting position is frequency x, and the frequency domain occupation length is y, then, the uplink frequency domain resource can be a frequency band with the length y starting from frequency x; and
for example, the terminal can determine the uplink frequency domain resource according to the frequency domain starting position and the frequency domain ending position, for example, the frequency domain starting position is frequency x1, and the frequency domain ending position is frequency x2, then, the uplink frequency domain resource can be a frequency band between frequency x1 and frequency x2.

Therefore, after determining the uplink frequency domain resource, the terminal can perform uplink transmission by using the uplink frequency domain resource within indicated uplink time domain resource.

In an embodiment, in the case that the uplink indication information is carried in the system information, the RRC signaling, or the group common DCI:
the time domain indication information includes time domain pattern information.

When the uplink indication information is carried in the system information or the RRC signaling, generally, the system information or the RRC signaling is not dynamically sent, and therefore, it is not easy to achieve dynamic scheduling. Therefore, the uplink time domain resource can be scheduled in a semi-static mode. For example, in this case, the time domain indication information can include the time domain pattern information, such as a time domain pattern information bitmap by which the uplink time domain resource is indicated.

For example, the uplink frequency domain resource is the subband, then, the terminal can determine, according to the time domain pattern information, a time domain resource where the subband is located, for example, the slot where the subband is located. The time domain resource corresponding to the time domain pattern information can be continuous, for example, there are a plurality of continuous slots; and the time domain resource can also be discontinuous, for example, there are a plurality of spaced slots, for example, the plurality of slots can be periodic slots.

Of course, in addition to that the uplink indication information is carried in the system information or the RRC signaling, the uplink time domain resource can be indicated by the time domain pattern information. When the uplink indication information is carried in other modes, the uplink time domain resource can also be indicated as required according to the time domain pattern information. For example, when the uplink indication information is carried in the DCI, specifically, when it is carried in the group common DCI, the time domain indication information can also include the time domain pattern information (such as the bitmap), that is, in this case, the uplink time domain resource can also be indicated by the time domain pattern information.

In an embodiment, the specific DCI includes at least one of following information:
specific DCI for scheduling downlink transmission; or
specific uplink control information for scheduling uplink transmission.

The specific DCI carrying the uplink indication information is sent for the specified terminal, and therefore, it can be specifically referred to as UE specific DCI, where UE refers to the specified terminal.

The specific DCI can be the specific DCI for scheduling downlink transmission of the terminal, in this case, the terminal can determine a downlink transmission resource according to the specific DCI, and can also determine an uplink transmission resource according to the uplink indication information in the specific DCI; and
the specific DCI can also be the specific uplink control information for scheduling uplink transmission of the terminal, in this case, a part of contents in the specific DCI can be used as the uplink indication information. For example, the terminal can determine a part of contents, used as the uplink indication information, in the specific DCI according to an agreement, and can also determine a part of contents, used as the uplink indication information, in the specific DCI according to an indication from the network-side device.

In an embodiment, the uplink indication information includes a newly added field in the specific DCI. That is, compared with the specific DCI in the related art, a field (such as a new information domain) can be newly added therein, and the newly added field is used as the uplink indication information to indicate the uplink resource.

In an embodiment, in the case that the specific DCI is the specific uplink control information for scheduling uplink transmission, the uplink indication information includes a part of bits in a frequency domain resource assignment domain in the specific DCI.

In the case that the specific DCI is the specific uplink control information, the uplink frequency domain resource can be assigned by the FDRA domain in the specific DCI.

It should be noted that assigning the uplink frequency domain resource and indicating the uplink frequency domain resource are different in meaning. Indicating the uplink frequency domain resource is to indicate the uplink frequency domain resource for uplink transmission in the downlink frequency domain resource for downlink transmission, for example, to indicate a subband for uplink transmission in a downlink frequency band for downlink transmission; and assigning the uplink frequency domain resource is to assign an RB (Resource Block) for uplink transmission in a determined uplink frequency domain resource (such as the above-mentioned subband).

At present, the FDRA domain aims at assigning the uplink frequency domain resource, and a length of the FDRA domain is related to a size of an activated BWP (Bandwidth Part). For example, the length of the FDRA domain is 10 bits, then, in a general case, it is not all the bits in the FDRA domain that are used for assigning the uplink frequency domain resource. Therefore, in the present embodiment, a part of the bits in the FDRA domain can be used as the uplink indication information, for example, N (N is an integer greater than 0) MSB (Most Significant Bit) or N LSB (Least Significant Bit) in the FDRA domain can be used as the uplink indication information.

With N MSB in the FDRA domain as the uplink indication information as an example, if the length of the FDRA domain is 10 bits, and N is 2 bits, first two bits in the FDRA domain can be used as the uplink indication information, and the last eight bits are still used for uplink resource assignment. Therefore, the FDRA domain can be fully utilized to indicate the uplink resource without changing an information domain in existing DCI.

In an embodiment, the network-side device can configure, through the RRC signaling, N MSB or N LSB as the uplink indication information to indicate the uplink resource;
or, the network-side device can pre-configure a plurality of candidate resources (which will be specifically described in subsequent embodiments) for the terminal, for example, C candidate resources are pre-configured, and the terminal can determine a value of N according to the number C of the candidate resources, for example, N=ceil(log₂(C)); and
or, the terminal can pre-store a corresponding relationship between an uplink BWP (Bandwidth Part) for uplink transmission and the value of N, and then implicitly determine the corresponding value of N in the corresponding relationship according to the currently activated uplink BWP.

In an embodiment, the method further includes:
a length of the FDRA domain is determined according to an activated uplink bandwidth part.

In an embodiment, there may be an association relationship between the length (the number of the corresponding bits) of the FDRA domain and the BWP. In the present embodiment, the uplink resource is located in the downlink resource, but the FDRA domain in the specific DCI is used for frequency domain resource assignment for the uplink resource, and therefore, the length of the FDRA domain needs to be determined according to the activated uplink BWP (the bandwidth is smaller than or equal to a downlink BWP), for example, the length of the FDRA domain corresponding to the activated uplink BWP can be determined in the association relationship between the length of the FDRA domain and the BWP. Then, after the length of the FDRA domain is determined, N bits in the FDRA domain can be determined as the uplink indication information, and other bits are used for frequency domain resource assignment.

In an embodiment, in the case that the uplink indication information is carried in the specific DCI or the group common DCI, the step that an uplink resource for uplink transmission in a downlink resource for downlink transmission is determined according to the uplink indication information includes:
the uplink resource is determined in a plurality of predetermined candidate resources according to the uplink indication information.

In an embodiment, the plurality of predetermined candidate resources can be pre-configured for the terminal by the network-side device according to high-layer signaling (such as the RRC signaling), or can be predetermined by the network-side device and the terminal according to an agreement, and then, the network-side device can select one resource from the plurality of candidate resources as required and indicate it to the terminal according to the uplink indication information (for example, carried in the specific DCI), for example, indicate an identifier corresponding to the selected resource to the terminal.

In an embodiment, for example, the network-side device can pre-configure a corresponding relationship between each of the plurality of candidate resources and the identifier for the terminal, and a storage mode of the corresponding relationship includes, but is not limited to a table, such as Table 1 shown as above.

As shown in Table 1, for example, the candidate resources can be specifically a set of configurations including the uplink time domain resource and the uplink frequency domain resource, and the configurations can, for example, include a starting position of a subband, a frequency domain occupation length of the subband, and time domain pattern information. For example, there are C configurations, i.e., C candidate resources, then, the network-side device can indicate the selected resource by N bits, where N-ceil(log₂(C)). For example, there are four sets of configurations in Table 1, i.e., four candidate resources, then, the network-side device can indicate the selected resource by two bits, for example, the uplink indication information is 01 which represents that the terminal is indicated to perform uplink transmission by using the second set of configurations.

FIG. 8 is a schematic flow diagram illustrating another uplink transmission determination method according to an embodiment of the present disclosure. As shown in FIG. 8, the method further includes:
in step S801, uplink transmission on the uplink resource is stopped according to disable information sent by the network-side device.

In an embodiment, the terminal can perform uplink transmission according to the uplink resource indicated by the uplink indication information, and then stop, according to the disable information sent by the network-side device, uplink transmission on the uplink resource indicated by the uplink indication information. The disable information can be carried in the DCI, for example, in the group common DCI.

Corresponding to the embodiments of the aforementioned uplink transmission indication method and uplink transmission determination method, the present disclosure further provides embodiments of an uplink transmission indication apparatus and an uplink transmission determination apparatus.

FIG. 9 is a schematic block diagram illustrating an uplink transmission indication apparatus according to an embodiment of the present disclosure. The uplink transmission indication apparatus shown in the present embodiment is suitable for a network-side device which can perform communication with a terminal. The terminal includes, but is not limited to a communication apparatus such as a mobile phone, a tablet personal computer, a wearable device, a sensor, and an Internet-of-things device; and the network-side device includes, but is not limited to a network-side device, such as a base station and a core network, in a communication system such as 4G, 5G and 6G.

As shown in FIG. 9, the uplink transmission indication apparatus may include:
a sending module 901 configured to send uplink indication information to a terminal, where the uplink indication information is used for indicating an uplink resource for uplink transmission in a downlink resource for downlink transmission of the terminal.

In an embodiment, the uplink indication information includes at least one of following information:
frequency domain indication information for indicating an uplink frequency domain resource for uplink transmission in a downlink frequency domain resource for downlink transmission of the terminal; or
time domain indication information for indicating an uplink time domain resource for uplink transmission in a downlink time domain resource for downlink transmission of the terminal.

In an embodiment, the uplink frequency domain resource includes at least one subband in the downlink frequency domain resource.

In an embodiment, the uplink indication information is carried in at least one of following items:
system information;
RRC signaling;
specific DCI;
group common DCI; or
an MAC CE.

In an embodiment, in the case that the uplink indication information is carried in the system information, or the RRC signaling:
the frequency domain indication information is used for indicating a frequency domain starting position and a frequency domain occupation length of the uplink frequency domain resource, or the frequency domain indication information is used for indicating a frequency domain starting position and a frequency domain ending position of the uplink frequency domain resource.

In an embodiment, in the case that the uplink indication information is carried in the system information, or the RRC signaling, or the group common DCI:
the time domain indication information includes time domain pattern information.

In an embodiment, the specific DCI includes at least one of following information:
specific DCI for scheduling downlink transmission; and
specific uplink control information for scheduling uplink transmission.

In an embodiment, the uplink indication information includes a newly added field in the specific DCI.

In an embodiment, in the case that the specific DCI is the specific uplink control information for scheduling uplink transmission:

the uplink indication information includes a part of bits in an FDRA domain in the specific DCI.

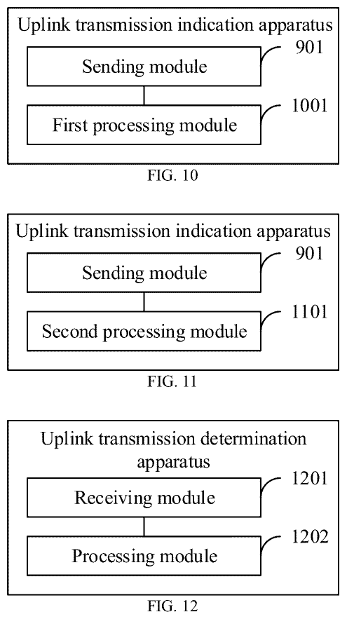

FIG. 10 is a schematic block diagram illustrating another uplink transmission indication apparatus according to an embodiment of the present disclosure. As shown in FIG. 10, the apparatus further includes:
a first processing module 1001 configured to determine a length of the FDRA domain according to an activated uplink bandwidth part.

In an embodiment, in the case that the uplink indication information is carried in the specific DCI or the group common DCI:
the uplink indication information is used for indicating the uplink resource in a plurality of predetermined candidate resources.

FIG. 11 is a schematic block diagram illustrating further uplink transmission indication apparatus according to an embodiment of the present disclosure. As shown in FIG. 11, the apparatus further includes:
a second processing module 1101 configured to send disable information to the terminal, where the disable information is used for instructing the terminal to stop uplink transmission on the uplink resource.

It should be noted that the first processing module and the second processing module may be the same processing module or different processing modules.

FIG. 12 is a schematic block diagram illustrating an uplink transmission determination apparatus according to an embodiment of the present disclosure. The uplink transmission determination apparatus shown in the present embodiment is suitable for a terminal which can perform communication with a network-side device. The terminal includes, but is not limited to a communication apparatus such as a mobile phone, a tablet personal computer, a wearable device, a sensor, and an Internet-of-things device; and the network-side device includes, but is not limited to a network-side device, such as a base station and a core network, in a communication system such as 4G, 5G and 6G.

As shown in FIG. 12, the uplink transmission determination apparatus includes:
a receiving module 1201 configured to receive uplink indication information sent by a network-side device; and
a processing module 1202 configured to determine an uplink resource for uplink transmission in a downlink resource for downlink transmission according to the uplink indication information.

In an embodiment, the uplink indication information includes at least one of following information:
frequency domain indication information; or
time domain indication information;
where the processing module is configured to perform at least one of following steps:
an uplink frequency domain resource for uplink transmission in a downlink frequency domain resource for downlink transmission is determined according to the frequency domain indication information; or
an uplink time domain resource for uplink transmission in a downlink time domain resource for downlink transmission is determined according to the time domain indication information.

In an embodiment, the uplink frequency domain resource includes at least one subband in the downlink frequency domain resource.

In an embodiment, the uplink indication information is carried in at least one of following items:
system information;
RRC signaling;
specific DCI;
group common DCI; or
an MAC CE.

In an embodiment, in the case that the uplink indication information is carried in the system information, or the RRC signaling, or the group common DCI, the processing module is configured to:
determine a frequency domain starting position and a frequency domain occupation length of the uplink frequency domain resource according to the frequency domain indication information, or determine a frequency domain starting position and a frequency domain ending position of the uplink frequency domain resource according to the frequency domain indication information.

In an embodiment, in the case that the uplink indication information is carried in the system information, or the RRC signaling, or the group common DCI:
the time domain indication information includes time domain pattern information.

In an embodiment, the specific DCI includes at least one of following information:
specific DCI for scheduling downlink transmission; or
specific uplink control information for scheduling uplink transmission.

In an embodiment, the uplink indication information includes a newly added field in the specific DCI.

In an embodiment, in the case that the specific DCI is the specific uplink control information for scheduling uplink transmission:
the uplink indication information includes a part of bits in an FDRA domain in the specific DCI.

In an embodiment, the processing module is further configured to determine a length of the FDRA domain according to an activated uplink bandwidth part.

In an embodiment, in the case that the uplink indication information is carried in the specific DCI or the group common DCI, the processing module is configured to:
determine the uplink resource in a plurality of predetermined candidate resources according to the uplink indication information.

In an embodiment, the processing module is further configured to stop uplink transmission on the uplink resource according to disable information sent by the network-side device.

As for the apparatus in the above-mentioned embodiment, specific modes in which each module performs operations have been described in detail in the embodiments of the related methods so as not to be described in detail herein.

For apparatus embodiments, the apparatus embodiments basically correspond to the method embodiments, and therefore, related description can refer to the description for the part of the method embodiments. The apparatus embodiments described as above are only schematic, where the modules described as separation components may be or not be physically separated, and components serving as modules for display may be or not be physical modules, that is, they may be located on the same place or distributed on a plurality of network modules. Parts or all of the modules may be selected according to an actual demand to achieve the purpose of the solution in the present embodiment. The present disclosure can be understood and implemented by those of ordinary skill in the art without creative efforts.

An embodiment of the present disclosure further provides a communication apparatus, including a processor; and a memory for storing a computer program; where the computer program is executed by the processor to implement the uplink transmission indication method according to any one of the above-mentioned embodiments.

An embodiment of the present disclosure further provides a communication apparatus, including a processor; and a memory for storing a computer program; where the computer program is executed by the processor to implement the uplink transmission determination method according to any one of the above-mentioned embodiments.

An embodiment of the present disclosure further provides a computer-readable storage medium for storing a computer program, where the computer program is executed by a processor to implement the steps of the uplink transmission indication method according to any one of the above-mentioned embodiments.

An embodiment of the present disclosure further provides a computer-readable storage medium for storing a computer program, where the computer program is executed by a processor to implement the steps of the uplink transmission determination method according to any one of the above-mentioned embodiments.

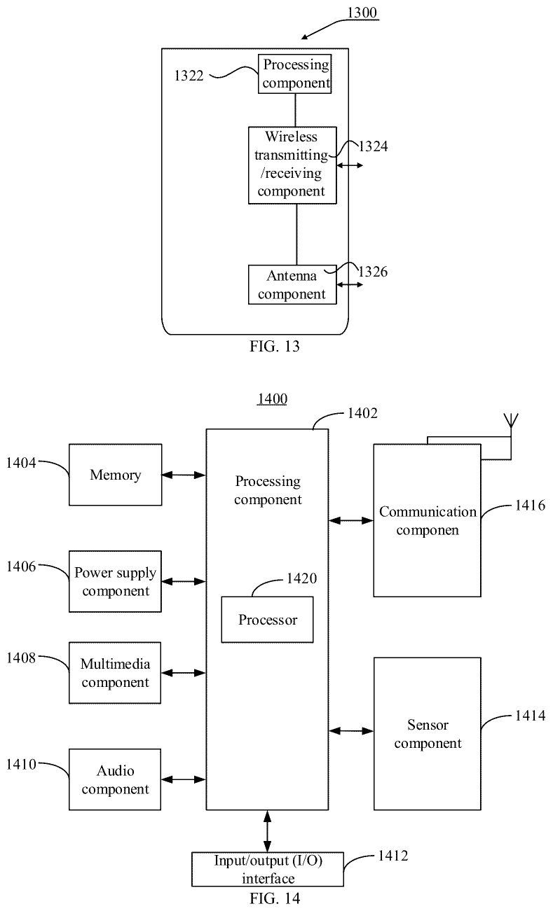

As shown in FIG. 13 which is a schematic block diagram illustrating an apparatus 1300 for uplink transmission indication according to an embodiment of the present disclosure, the apparatus 1300 can be provided as a base station. With reference to FIG. 13, the apparatus 1300 includes a processing component 1322, a wireless transmitting/receiving component 1324, an antenna component 1326, and a signal processing part special for a wireless interface, the processing component 1322 can further include one or more processors. One processor in the processing component 1322 can be configured to implement the uplink transmission indication method according to any one of the above-mentioned embodiments.

FIG. 14 is a schematic block diagram illustrating an apparatus 1400 for uplink transmission determination according to an embodiment of the present disclosure. For example, the apparatus 1400 may be a mobile phone, a computer, a digital broadcast terminal, a message transceiving device, a game console, a tablet device, a medical device, a fitness device, a personal digital assistant, etc.

With reference to FIG. 14, the apparatus 1400 can include one or more of following components: a processing component 1402, a memory 1404, a power supply component 1406, a multimedia component 1408, an audio component 1410, an input/output (I/O) interface 1412, a sensor component 1414, and a communication component 1416.

The processing component 1402 usually controls the overall operation, such as operations associated with display, telephone call, data communication, camera operation, and recording operation, of the apparatus 1400. The processing component 1402 may include one or more processors 1420 to execute instructions so as to complete all or parts of the steps of the above-mentioned uplink transmission determination method. In addition, the processing component 1402 may include one or more modules which facilitate interaction between the processing component 1402 and other components. For example, the processing component 1402 may include a multimedia module to facilitate interaction between the multimedia component 1408 and the processing component 1402.

The memory 1404 is configured to store various types of data to support operations on the apparatus 1400. Examples of the data include instructions for any applications or methods operated on the apparatus 1400, contact data, telephone directory data, messages, pictures, videos, etc. The memory 1404 can be achieved by any types of volatile or nonvolatile storage devices or combinations thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power supply component 1406 provides power for various components of the apparatus 1400. The power supply component 1406 may include a power supply management system, one or more power supplies, and other components associated with the generation, management and power distribution of the apparatus 1400.

The multimedia component 1408 includes a screen located between the apparatus 1400 and a user and provided with an output interface. In some embodiments, the screen may include a liquid crystal display (LCD) and a touch panel (TP). If the screen includes the touch panel, the screen can be achieved as a touch screen to receive an input signal from the user. The touch panel includes one or more touch sensors to sense touching, sliding and gestures on the touch panel. The touch sensors not only can sense a boundary of a touching or sliding action, but also can detect a duration and a pressure related to the touching or sliding operation. In some embodiments, the multimedia component 1408 includes a front camera and/or a rear camera. When the apparatus 1400 is in an operating mode, such as a shooting mode or a video mode, the front camera and/or the rear camera can receive external multimedia data. Each of the front camera and the rear camera can be a fixed optical lens system or have a focal length or an optical zooming ability.

The audio component 1410 is configured to output and/or input an audio signal. For example, the audio component 1410 includes a microphone (MIC). When the apparatus 1400 is in an operating mode, such as a calling mode, a recording mode and a voice recognition mode, the microphone is configured to receive an external audio signal. The received audio signal may be further stored in the memory 1404 or sent by the communication component 1416. In some embodiments, the audio component 1410 further includes a loudspeaker for outputting the audio signal.

The I/O interface 1412 is an interface provided between the processing component 1402 and a peripheral interface module, and the above-mentioned peripheral interface module may be a keyboard, a click wheel, buttons, etc. These buttons may include, but are not limited to: a homepage button, a volume button, a starting button, and a locking button.

The sensor component 1414 includes one or more sensors for providing state evaluation in various aspects for the apparatus 1400. For example, the sensor component 1414 can detect an on/off state of the apparatus 1400 and relative positioning of the components, for example, the components are a display and a keypad of the apparatus 1400; and the sensor component 1414 can also detect position change of the apparatus 1400 or a component of the apparatus 1400, the existence of contact between the user an the apparatus 1400, the direction or acceleration/deceleration of the apparatus 1400, and temperature change of the apparatus 1400. The sensor component 1414 may include a proximity sensor configured to detect the existence of a nearby object when there is no any physical contact. The sensor component 1414 may further include an optical sensor, such as a CMOS or CCD image sensor used in imaging applications. In some embodiments, this sensor component 1414 may further include an acceleration sensor, a gyroscope sensor, a magnetic sensor, a pressure sensor, or a temperature sensor.

The communication component 1416 is configured to facilitate communication between the apparatus 1400 and any other device in a wired or wireless mode. The apparatus 1400 may be accessed to a wireless network based on a communication standard, such as WiFi, 2G, 3G, 4G LTE, 5G NR or combinations thereof. In an example, the communication component 1416 receives a broadcast signal or broadcast related information from an external broadcast management system through a broadcast channel. In an example, the communication component 1416 further includes a near field communication (NFC) module to promote short-range communication. For example, the NFC module can be achieved based on a radio frequency identification (RFID) technology, an infrared data association (IrDA) technology, an ultrawide band (UWB) technology, a Bluetooth (BT) technology, and other technologies.

In an example, the apparatus 1400 can be achieved by one or more application specific integrated circuits (ASIC), digital signal processors (DSP), digital signal processing devices (DSPD), programmable logic devices (PLD), field programmable gate arrays (FPGA), controllers, micro-controllers, microprocessors or other electronic elements, and is used for performing the above-mentioned uplink transmission determination method.

In an example, further provided is a non-temporary computer-readable storage medium including instructions, such as the memory 1404 including instructions, and the above-mentioned instruction can be executed by the processors 1420 of the apparatus 1400 so as to complete the above-mentioned uplink transmission determination method. For example, the non-temporary computer-readable storage medium may be an ROM, a random access medium (RAM), a CD-ROM, a magnetic tape, a floppy disk, an optical data storage device, etc.

Those skilled in the art will readily envision other implementation solutions of the present disclosure after considering the specification and putting the present disclosure disclosed herein into practice. The present disclosure aims at covering any variations, purposes or adaptive changes of the present disclosure, and these variations, purposes or adaptive changes conform to a general principle of the present disclosure and include common general knowledge or conventional technical means in the undisclosed technical field of the present disclosure. The specification and the embodiments are only regarded to be as examples, and the true scope and spirit of the present disclosure are appointed by the following claims.

It should be understood that the present disclosure is not limited to precise structures which have been described above and shown in the accompanying drawings, and various modifications and alterations may be made without departing from the scope thereof. The scope of the present disclosure is only limited by the appended claims.

It should be noted that relational terms such as first and second described herein are only used to distinguish one entity or operation from another one, but do not necessarily require or imply the presence of any such actual relationship or order between these entities or operations. Terms “includes,” “including,” or any other variants thereof are intended to cover non-excludable inclusion, so that a process, method, article or device including a series of elements not only includes those elements, but also includes other elements not listed clearly, or further includes inherent elements of the process, method, article or device. In a case that there are no more limitations, elements defined by the word “including a . . . ” do not exclude other same elements further existing in the process, method, article or device including the elements.

The methods and apparatuses provided in the embodiments of the present disclosure have been introduced above in detail. The principles and implementations of the present disclosure have been described by applying specific examples in the present disclosure, and the description for the above-mentioned embodiments is only intended to help the understanding of the methods and core concepts thereof in the present disclosure. At the same time, those of ordinary skill in the art may make changes on specific implementations and application scopes according to the concept of the present disclosure. In conclusion, contents in the present specification should not be understood as limitations on the present disclosure.

1. An uplink transmission indication method performed by a network-side device, comprising:
sending uplink indication information to a terminal, wherein the uplink indication information is for indicating an uplink resource for uplink transmission in a downlink resource for downlink transmission of the terminal.

2. The uplink transmission indication method according to claim 1, wherein the uplink indication information comprises at least one of:
frequency domain indication information for indicating an uplink frequency domain resource for uplink transmission in a downlink frequency domain resource for the downlink transmission of the terminal; or
time domain indication information for indicating an uplink time domain resource for the uplink transmission in a downlink time domain resource for the downlink transmission of the terminal.

3. The uplink transmission indication method according to claim 2, wherein the uplink frequency domain resource comprises at least one subband in the downlink frequency domain resource.

4. The uplink transmission indication method according to claim 2, wherein the uplink indication information is carried in at least one of:
system information;
radio resource control signaling;
specific downlink control information;
group common downlink control information; or
a media access control element.

5. The uplink transmission indication method according to claim 4, wherein in response to the uplink indication information being carried in the system information or the radio resource control signaling,
the frequency domain indication information is for indicating a frequency domain starting position and a frequency domain occupation length of the uplink frequency domain resource, or the frequency domain indication information is for indicating a frequency domain starting position and a frequency domain ending position of the uplink frequency domain resource.

6. The uplink transmission indication method according to claim 4, wherein in response to the uplink indication information being carried in the system information, the radio resource control signaling, or the group common downlink control information,
the time domain indication information comprises time domain pattern information.

7. The uplink transmission indication method according to claim 4, wherein the specific downlink control information comprises at least one of:
specific downlink control information for scheduling downlink transmission; or
specific uplink control information for scheduling uplink transmission;
wherein the uplink indication information comprises a newly added field in the specific downlink control information; and/or
wherein in response to the specific downlink control information being the specific uplink control information for scheduling uplink transmission, the uplink indication information comprises a part of bits in a frequency domain resource assignment domain in the specific downlink control information; and a length of the frequency domain resource assignment domain is determined according to an activated uplink bandwidth part.

8.-10. (canceled)

11. The uplink transmission indication method according to claim 4, wherein in response to the uplink indication information being carried in the specific downlink control information or the group common downlink control information,
the uplink indication information is for indicating the uplink resource in a plurality of predetermined candidate resources.

12. The uplink transmission indication method according to claim 1, further comprising:
sending disable information to the terminal, wherein the disable information is for instructing the terminal to stop uplink transmission on the uplink resource.

13. An uplink transmission determination method performed by a terminal, comprising:
receiving uplink indication information sent by a network-side device; and
determining an uplink resource for uplink transmission in a downlink resource for downlink transmission according to the uplink indication information.

14. The uplink transmission determination method according to claim 13, wherein the uplink indication information comprises at least one of:
frequency domain indication information; or
time domain indication information;
wherein determining the uplink resource for uplink transmission in the downlink resource for the downlink transmission according to the uplink indication information comprises at least one of:
determining an uplink frequency domain resource for the uplink transmission in a downlink frequency domain resource for the downlink transmission according to the frequency domain indication information; and
determining an uplink time domain resource for the uplink transmission in a downlink time domain resource for the downlink transmission according to the time domain indication information.

15. The uplink transmission determination method according to claim 14, wherein the uplink frequency domain resource comprises at least one subband in the downlink frequency domain resource.

16. The uplink transmission determination method according to claim 14, wherein the uplink indication information is carried in at least one of:
system information;
radio resource control signaling;
specific downlink control information;
group common downlink control information; or
a media access control element.

17. The uplink transmission determination method according to claim 16, wherein in response to the uplink indication information being carried in the system information or the radio resource control signaling, determining the uplink resource for the uplink transmission in the downlink resource for the downlink transmission according to the uplink indication information comprises:
determining a frequency domain starting position and a frequency domain occupation length of the uplink frequency domain resource according to the frequency domain indication information, or determining a frequency domain starting position and a frequency domain ending position of the uplink frequency domain resource according to the frequency domain indication information.

18. The uplink transmission determination method according to claim 16, wherein in response to the uplink indication information being carried in the system information, the radio resource control signaling, or the group common downlink control information,
the time domain indication information comprises time domain pattern information.

19. The uplink transmission determination method according to claim 16, wherein the specific downlink control information comprises at least one of:
specific downlink control information for scheduling downlink transmission; or
specific uplink control information for scheduling uplink transmission;
wherein the uplink indication information comprises a newly added field in the specific downlink control information; and/or
wherein in response to the specific downlink control information being the specific uplink control information for scheduling uplink transmission, the uplink indication information comprises a part of bits in a frequency domain resource assignment domain in the specific downlink control information; and a length of the frequency domain resource assignment domain is determined according to an activated uplink bandwidth part.

20.-22. (canceled)

23. The uplink transmission determination method according to claim 16, wherein in response to the uplink indication information being carried in the specific downlink control information or the group common downlink control information, determining the uplink resource for the uplink transmission in the downlink resource for the downlink transmission according to the uplink indication information comprises:
determining the uplink resource in a plurality of predetermined candidate resources according to the uplink indication information.

24. The uplink transmission determination method according to claim 13, further comprising:
stopping uplink transmission on the uplink resource according to disable information sent by the network-side device.

25.-26. (canceled)

27. A communication apparatus, comprising:
one or more processors; and
a memory for storing a computer program;
wherein the computer program when executed by the one or more processors cause the one or more processors to collectively:
send uplink indication information to a terminal, wherein the uplink indication information is for indicating an uplink resource for uplink transmission in a downlink resource for downlink transmission of the terminal.

28. (canceled)

29. A non-transitory computer-readable storage medium for storing a computer program, wherein the computer program when executed by a processor cause the processor to execute the uplink transmission indication method according to claim 1.

30. (canceled)
